(19) United States
(12) Patent Application Publication
(10) Pub. No.: US 2020/0070209 A1
(43) Pub. Date: Mar. 5, 2020

(54) MACHINE AND METHOD TO SEPARATE WOOD-BASED MATERIALS FROM OTHER MATERIALS

(71) Applicant: PAL S.R.L., Ponte Di Piave (IT)

(72) Inventor: Michele Libralato, Quinto di Treviso (IT)

(21) Appl. No.: 16/613,641

(22) PCT Filed: May 18, 2018
(86) PCT No.: PCT/IT2018/050087

§ 371 Date: Nov. 14, 2019

(30) Foreign Application Priority Data
May 19, 2017 (IT) 102017000054728

(51) Int. Cl. B07C 5/36; B07C 5/34

(52) U.S. Cl. CPC B07C 5/368; B07C 2501/0018; B07C 5/34

(57) ABSTRACT

Machine and method to separate wood-based materials from other materials. A conveyor belt conveys the group of materials to be separated toward detection members that detect the presence of materials with an organic origin and/or metal materials. Compressed air nozzles selectively thrust downward the materials with an organic origin and/or the metal materials detected by the detection members, under the control of an electronic control unit. A blowing device is disposed downstream of the nozzles to blow air toward the wood-based materials that transit due to inertia above them and thrust them beyond a separation element disposed downstream of the blowing device, while the inert materials, which have a bigger specific weight than the wood-based materials, fall downward due to gravity.

### FIELD OF THE INVENTION

The field of application of the present invention is the separation of wood-based materials, such as for example pieces of wood, shavings, or wood chips, from other non-wood materials, such as for example plastic materials, rubber, metal materials, or inert materials, such as for example glass, stones, rocks, or pieces of brick, which is a preliminary operation prior to making wood-based panels.

### BACKGROUND OF THE INVENTION

In the field of wood-based panels, such as for example with particle board (PB), MDF, OSB, the treatment of the flow of wood in the so-called “green” zone of the plant is an essential step for the subsequent production step proper of the panels, including drying, gluing, forming and pressing.

In particular, in the “green” zone, the recycled wood requires several cleaning passes to eliminate mainly metal pollutants and inert materials.

In recent years, the growing demand for high quality recycled wood to produce better quality chipboard panels and reduce production costs has led to the development and implementation in this sector of sensor-based selection technologies, which typically comprise inductive sensors for the detection of metals, both ferrous and non-ferrous, and spectrographic, or so-called “NIR” cameras, that is, “near infrared”, with wavelengths from 900 to 1,700 nanometers, to detect pollutants of organic origin, typically plastic materials and rubber.

Detection with X-ray transmission or fluorescence (Xrt, Xrf) is also known, for all materials with densities significantly different from wood, that is, metals, inert materials, such as stones and glass for example, some types of plastic materials and rubber.

Irrespective of the detection system used, that is, sensors, NIR cameras, or Xrt, known selection machines use a battery of compressed air nozzle to expel the pollutants detected on a flow of material conveyed on a conveyor belt.

X-ray technology (Xrt, Xrf) to date is the only one among those so-called “sensor based” technologies that allows the simultaneous detection and selection of metals and inert materials, including light ones that cannot be separated easily using air or water systems, which exploit the different densities, and/or the different aerodynamic behavior of the materials.

Having the possibility to select metals and inert materials simultaneously gives the advantage of needing to have fewer machines in the “green” zone and of compacting the layout of the plant, with consequent advantages in terms of less space required and in terms of transport. For this reason X-ray technology is taken into consideration by panel producers, although there are the following contraindications in the use of X-rays: dangers connected to the radiation produced by X-rays; high management/maintenance costs of related equipment; the need for expert specialized personnel, for example radiologists, in the use of X-ray equipment.

Furthermore, Xrf, Xrt technologies in any case are not able to effectively distinguish wood from other materials of organic origin having densities similar to wood, including plastic materials, rubber, wood derivatives, plastic-coated wood and suchlike.

Documents WO-A-00/58035 and US-A-2015/0231671 discloses a separation machine according to the preamble of claim 1, namely a separation machine for separating wood-based materials from other materials, comprising a conveyor belt that defines an upper support plane, feed means configured to collect and convey the group of materials to be separated toward a first end of said upper support plane, motor means configured to make said conveyor belt advance at a determinate transport speed to take said materials to be separated toward a second end of said upper support plane, detection means associated with said upper support plane and configured to detect the presence of materials with an organic origin and/or metal materials between said materials to be separated, a plurality of compressed air nozzles, disposed downstream of said second end of said upper support plane, a little above the latter and at a first distance from said detection means, said nozzles being configured to selectively thrust downward, using compressed air, said materials with an organic origin and/or said metal materials detected by said detection means, under the control of electronic control means that process the signals arriving from said detection means.

Also, document EP-A-1 533 045 shows a raw of nozzles and a blower, however, the first raw of nozzles is configured to thrust upward.

A first purpose of the present invention is therefore to overcome the disadvantages of the state of the art, obtaining a machine and perfecting the corresponding method, which are able to select simultaneously, efficiently, effectively and reliably all types of materials, without using X-rays.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a separation machine according to the present invention, to separate wood-based materials from other materials, comprises a conveyor belt that defines an upper support plane, feed means configured to collect and convey the group of materials to be separated toward a first end of the upper support plane, motor means configured to make the conveyor belt advance at a determinate transport speed to take the materials to be separated toward a second end of the upper support plane, detection means disposed in correspondence with the upper support plane and configured to detect the presence of materials with an organic origin and/or metal materials between the materials to be separated, a plurality of compressed air nozzles, disposed downstream of the second end of the upper support plane, a little above the latter and at a first distance from the detection means. The nozzles are configured to selectively thrust downward, using compressed air, the materials with an organic origin and/or the metal materials detected by the detection means, under the control of electronic control means that process the signals arriving from the detection means.

In accordance with one characteristic of the present invention, the separation machine also comprises blowing means disposed downstream of the nozzles at a second distance from the second end of the upper support plane and at a third distance below the latter, and configured to blow air toward the wood-based materials that transit due to inertia above them, arriving from the second end of the upper support plane, to thrust them beyond a separation mean disposed downstream of the blowing means to a fourth distance from the latter, while the inert materials, which have a bigger specific weight than the wood-based materials, fall downward due to gravity.

In accordance with another characteristic of the present invention, the separation machine also comprises a first collection zone disposed downstream and below the second end of the upper support plane and configured to collect the materials of organic origin and/or the metal materials thrust downward by the nozzles, and the inert materials arriving from the conveyor belt.

In accordance with another characteristic of the present invention, the separation machine also comprises a second collection zone disposed downstream and below the separation mean, and configured to collect the wood-based materials thrust by the blowing means.

In accordance with another characteristic of the present invention, the separation machine also comprises a plurality of electro valves, each associated with one compressed air nozzle and configured to be selectively commanded by the electronic control means based on signals arriving from the detection means.

In accordance with another characteristic of the present invention, the separation method for separating wood-based materials from other materials, comprises a step of loading the material to be separated into feed means to convey them toward a first end of an upper support plane of a conveyor belt which is made to advance at a determinate transport speed toward a second end of the upper support base, a detection step, in which detection means associated with the upper support plane detect the possible presence of materials with an organic origin and/or metal materials among the materials to be separated, and a first separation step carried out by means of a plurality of compressed air nozzles disposed downstream of the second end of the upper support base and which thrust selectively downward, using compressed air, the materials with an organic origin and/or the metal materials detected by the detection means, under the control of electronic control means which operate on the basis of signals arriving from the detection means. The method also comprises a second separation step, carried out by blowing means disposed downstream and below the second end of the upper support plane that blow air on the material exiting from the latter and thrust only the wood-based material that transits due to inertia above them beyond a separation mean disposed downstream of the blowing means, while the inert materials, which have a bigger specific weight than the wood-based materials, fall downward due to gravity before reaching the separation mean.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a front schematic view of a separation machine according to the present invention;

FIG. 2 is a right lateral view of the machine of FIG. 1;

FIG. 3 is an enlarged detail of FIG. 2;

FIG. 4 is an enlarged and schematized detail of FIG. 1;

FIG. 5 is an enlarged detail of FIG. 4.

We must clarify that in the present description and claims, the sole function of the terms vertical, horizontal, upper, above and below and their declinations is to better illustrate the present invention with reference to the drawings, and must in no way be used to limit the scope of the invention or the field of protection defined by the claims. For example, by the term horizontal we mean a plane that can be both parallel to the line of the horizon, and also inclined, even by several degrees, for example up to 20°, with respect to it.

### DETAILED DESCRIPTION OF SOME EMBODIMENTS

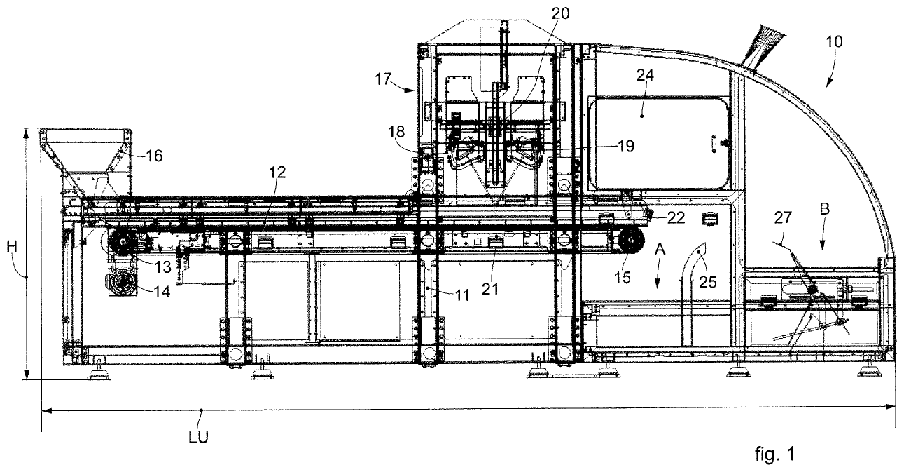

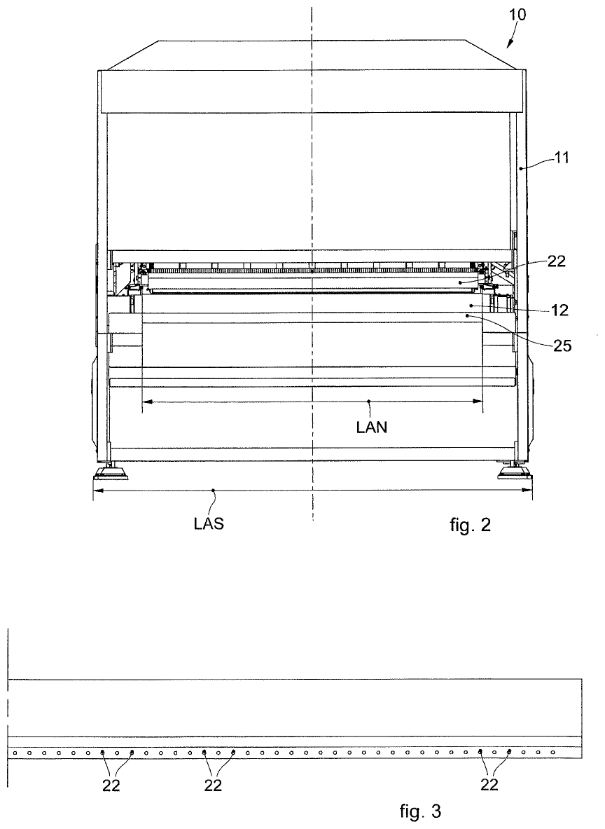

With reference to FIG. 1, a separation machine 10 according to the present invention comprises a fixed structure or frame 11 having, for example, a length LU of about 4 to 8 m, a height H of about 2.5 m and a width LAN (FIG. 2) of about 1 to 3 m.

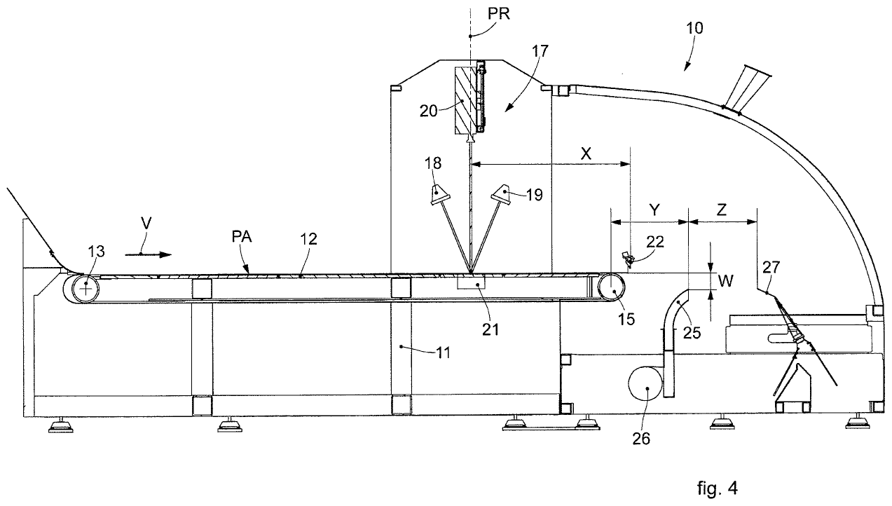

On the fixed structure 11 (FIG. 1) a conveyor belt 12 is mounted, which is stretched between a drawing roller 13, connected to an electric motor 14 by means of a pulley and belt, and a driven roller 15. The conveyor belt 12 defines an upper support plane PA (FIG. 4), substantially horizontal, and is configured to rotate in a clockwise direction. The width LAN (FIG. 2) of the conveyor belt 12 is slightly smaller than the width LAS of the fixed structure 11.

On the fixed structure 11, above the conveyor belt 12 and in correspondence with the drawing roller 13, a feed member is mounted, which in the example provided here is a hopper 16 (FIG. 1).

The electric motor 14 is fed so as to make the conveyor belt 12 advance at a high transport speed V, for example from about 5 to 8 m/sec.

On the fixed structure 11 there is also mounted a detection unit 17 which covers the entire width LAN of the conveyor belt 12 and which comprises, above the conveyor belt 12, two batteries of halogen lamps 18 and 19 (FIG. 4), which point directly on the upper support plane PA of the conveyor belt 12 below, and a series of NIR cameras 20 of a known type and disposed on a detection plane PR, for example substantially vertical, that is, perpendicular to the upper support plane PA, and pointed precisely on the latter.

According to a variant embodiment, the detection plane PR can be substantially horizontal, or inclined, by using a mirror.

The NIR cameras 20 are able to detect the passage of material of organic origin, such as plastic materials, rubber, wood derivatives, or suchlike, for example MDF panels, HPL panels, chipboard coated with plastic or melamine.

Moreover, the detection unit 17 also comprises a plurality of inductive sensors 21 of the known type, disposed just below the upper support plane PA of the conveyor belt 12, and configured to detect the passage of metal material, both ferrous and non-ferrous.

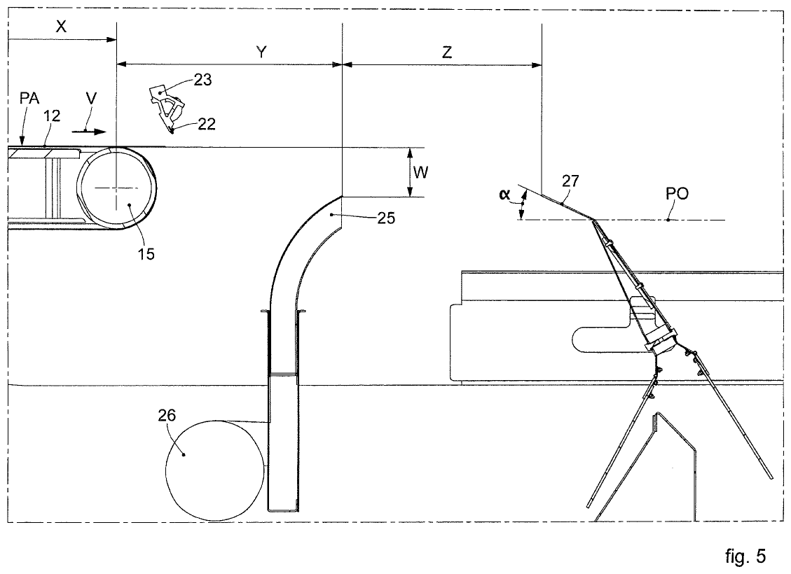

On the fixed structure 11, just downstream of the conveyor belt 12, that is, on its right in FIGS. 1 and 4, and at a first distance X from the detection plane PR, for example about 500 to 1500 mm, and slightly above the upper support plane PA, a battery of compressed-air nozzles 22 is disposed, each governed by a corresponding electro valve 23 (FIG. 5), very fast and of a known type.

The nozzles 22 (FIG. 3) are very close together and are distant from each other, for example, from about 6 to 12 mm. The pressure of the compressed air with which the nozzles 22 are selectively fed is, for example, about 5 to 8 bar (500 to 800 kPa).

Each electro valve 23 is selectively activated by an electronic control unit 24 (FIG. 1), also connected to the NIR cameras 20 and to the inductive sensors 21 to receive from them and process the corresponding digital signals. The electronic control unit 24 also controls, directly or indirectly, the electric motor 14, to obtain the desired transport speed V of the conveyor belt 12.

In this way, when the detection unit 17 detects the presence of a material of organic origin by means of the NIR cameras 20, or of metal, by means of the inductive sensors 21, it sends a corresponding signal to the electronic control unit 24 which, taking into account the transport speed V and the first distance X, activates the corresponding electro valve 23 connected to a determinate nozzle 22, which with the compressed air thrusts the detected material downward, into a first collection zone A below.

On the fixed structure 11, downstream of the battery of nozzles 22, that is, on its right in FIGS. 1 and 4, and at a second distance Y from the axis of the driven roller 15, for example about 100 to 500 mm, the outlet is disposed of a blowing device which comprises a blower 25 connected to a fan 26 to constantly or selectively blow air at a determinate pressure, for example from about 500 to 2000 Pa. Moreover, the top of the outlet of the blower 25 is advantageously disposed below the upper support plane PA, for example at a third distance W of about from 100 to 300 mm. The blower 25 is configured to effect, by blowing air, the separation of the wood-based material, which has a relatively low specific weight, from the inert materials, such as stones, rocks and glass for example, which have a higher specific weight, which have not been detected by the detection unit 17. In fact, the wood-based material will be blown toward the right, while the inert materials will fall downward due to gravity, into the first collection zone A below, performing a relatively short travel, proportional to their inertia force due to the transport speed V.

Moreover, on the fixed structure 11, downstream of the blower 25, that is, to the right in FIGS. 1 and 4, at a fourth distance Z from the latter, for example from about 400 to 1000 mm, a separation element 27 is disposed, consisting for example of a flap, inclined with respect to a horizontal plane PO by an angle α (FIG. 5), for example of about from 30° to 60°. The top of the separation element 27 is disposed substantially on the same horizontal plane as that of the blower 25, on the understanding that both the position and the inclination of each of them can be adjusted by adjustment means of a known type and not shown in the drawings.

In particular, as regards the blower 25, this is adjustable both in the air flow rate, and in inclination, and in height (third distance W), and also in the position along the longitudinal axis of the machine 10 (second distance Y), in order to adapt to the selection of the flows of the wood-based material different in density and humidity, and to the different speeds of the conveyor belt 12, which imply different trajectories of the flow exiting from the latter. The transport speed V of the conveyor belt 12 is connected to the delivery rate of the material processed by the machine 10, while the constraint of the singularity of the pieces for reading by the detection unit 17 always remains.

The wood-based materials exiting from the conveyor belt 12, thrust by the blower 25, will perform a travel that is relatively longer than that of the inert materials and, after they have passed the separation element 27, will fall into a second collection zone B below (FIG. 1).

The separation method to separate wood-based materials from other materials comprises a step of loading the material to be separated into the hopper 16, so that it falls onto the support plane PA of the conveyor belt 12 below. The high transport speed V of the latter causes the material to be separated to be disposed on a single layer (monolayer), without any overlapping of the different pieces, thus obtaining a so-called singularization of the pieces themselves, to allow the detection unit 17 to recognize them.

There then follows a detection step, in which the detection unit 17 detects the possible presence of materials of organic origin and of metal materials.

In a subsequent separation step, the actual separation is carried out, which is performed both by the selective activation of the nozzles 22, which cause the separation of the materials of organic origin and of the metal materials, which are thrust downward into the first collection zone A, and also by blowing air from the blower 25, which thrusts only the wood-based material beyond the separation element 27, into the second collection zone B, while the inert materials fall into the first collection zone A below.

It should be noted that with the machine 10 and with the corresponding separation method described heretofore, it is possible to simultaneously select all the types of pollutants present in a stream of recycled wood, without needing to use an X-ray detection machine, which would make the machine itself very expensive and not convenient for simultaneous selection. In fact, the cost of an X-ray detection machine is high and proportional to the detection width, which corresponds to the width LAS of the conveyor belt 12. Furthermore, an X-ray detection machine is not able to distinguish all types of plastics, rubber or wood derivatives, without the aid of an NIR camera.

It is clear that modifications and/or additions of parts may be made to the separation machine 10 and corresponding method as described heretofore, without departing from the field and scope of the present invention.

It is also clear that, although the present invention has been described with reference to some specific examples, a person of skill in the art shall certainly be able to achieve many other equivalent forms of separation apparatuses and methods to separate wood-based materials from other materials, having the characteristics as set forth in the claims and hence all coming within the field of protection defined thereby.

1. A separation machine for separating wood-based materials from other materials, the separation machine comprising:
a conveyor belt that defines an upper support plane;
feed means configured to collect and convey a group of materials to be separated toward a first end of said upper support plane;
a motor configured to make said conveyor belt advance at a determinate transport speed and to take said materials to be separated toward a second end of said upper support plane;
a detect or associated with said upper support plane and configured to detect the presence of materials with an organic origin and/or metal materials between said materials to be separated;
a plurality of compressed air nozzles disposed downstream of said second end of said upper support plane, above the latter and at a first distance from said detect or, said nozzles being configured to selectively thrust downward, using compressed air, said materials with an organic origin and/or said metal materials detected by said detect or, under the control of an electronic controller that is configured to process signals arriving from said detector;
a blower disposed downstream of said nozzles at a second distance (Y) from said second end of said upper support plane and at a third distance (W) below the latter; and
a separator disposed downstream of said blower, wherein
the blower is configured to blow air toward wood-based materials that transit above them, arriving from said second end of said upper support plane, to thrust them beyond the separator to a fourth distance (Z) from the latter, while allowing inert materials to fall downward due to gravity.

2. The separation machine of claim 1, further comprising a first collection zone disposed downstream and below said second end of said upper support plane and configured to collect both said materials of organic origin and/or said metal materials thrust downward by said nozzles and also said inert materials arriving from said conveyor belt.

3. The separation machine of claim 2, further comprising a second collection zone disposed downstream and below said separator, and configured to collect said wood-based materials thrust by said blower.

4. The separation machine of claim 1, further comprising a plurality of electro valves, each associated with one of said nozzles and configured to be selectively commanded by said electronic controller based on signals arriving from said detector.

5. The separation machine of claim 1, wherein said detector comprises one or more NIR cameras disposed above said upper support plane and configured to detect the passage of possible materials of organic origin and to send one or more corresponding electric signals to said electronic controller.

6. The separation machine of claim 1, wherein said detector comprise one or more inductive sensors disposed below said upper support plane and configured to detect the passage of possible metal materials and to send one or more corresponding electric signals to said electronic controller.

7. The separation machine of claim 1, wherein said first distance (X) is between 500 mm and 1500 mm.

8. The separation machine of claim 1, wherein said second distance is between 100 mm and 500 mm and said third distance is between 100 mm and 300 mm.

9. The separation machine of claim 1, wherein said fourth distance is between 400 mm and 1000 mm.

10. A separation method for separating wood-based materials from other materials, the separation method comprising:
loading the material to be separated into a feeder configured to convey the material toward a first end of an upper support plane of a conveyor belt configured to advance at a determinate transport speed toward a second end of said upper support plane;
detecting, using a detector associated with said upper support plane, the presence of materials with an organic origin and/or metal materials among said materials to be separated;
separating, using a plurality of compressed air nozzles disposed downstream of said second end of said upper support plane and which thrust selectively downward, said materials with an organic origin and/or said metal materials; and
separating, using a blower disposed downstream and below said second end of said upper support plane that is configured to blow air on the material exiting from the latter, only wood-based material that transits due to inertia above them beyond a separator disposed downstream of said blower while leaving inert materials having a higher specific weight than said wood-based materials to fall downward due to gravity prior to reaching said separator,
wherein the plurality of compressed air nozzles are under the control of an electronic controller which operates on the basis of signals arriving from said detector
